(19) United States
(12) Patent Application Publication
(10) Pub. No.: US 2017/0239128 A1
(43) Pub. Date: Aug. 24, 2017

(54) WALKER TRAY DEVICE AND METHOD

(71) Applicant: MARIA FLORA, CHICAGO, IL (US)

(72) Inventor: MARIA FLORA, CHICAGO, IL (US)

(21) Appl. No.: 15/442,072

(22) Filed: Feb. 24, 2017

Related U.S. Application Data
(60) Provisional application No. 62/299,049, filed on Feb. 24, 2016.

(51) Int. Cl. A61H 3/00; A47B 23/00

(52) U.S. Cl. CPC A61H 3/00; A47B 23/00; A61H 2003/004; A61H 2201/0161

(57) ABSTRACT

A walker tray device including a tray assembly; the tray assembly including a front-side, a back-side, a left-side, and a right-side, a top-side, and a bottom-side. The tray assembly affixable to a walker, with the tray assembly constructed from a transparent material such that surroundings are more viewable to the user through the walker tray device. Walker tray device includes one or more magnets affixed to the tray assembly such that ferrous-metallic articles can be affixed to the walker tray device by the magnets. The walker tray device is constructed from an impact-resistant material to provide improved safety and durability during use.

### CROSS-REFERENCE TO RELATED APPLICATION

The present application is related to and claims priority to U.S. Provisional Patent Application No. 62/299,049 filed Feb. 24, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of walkers and trays of the existing art and more specifically relates to trays and articles to be affixed to walkers.

2. Description of Related Art

A walker is a device to provide stability and support to individuals while traveling on foot. Often times the individual may be infirmed, injured, or disabled. People who use walkers may have an attached device to the walker in order to transport various items such as meals, beverages, or a mobile phone that would otherwise be uncarryable while using a walker.

Walker trays are often large and solid, impeding the view of the walker user. Also, walker trays are constructed generally from materials that are not transparent. As such, the user is unable to see the floor and may be put at risk for falls and injuries due to obstructions. If a user chooses to not use a walker tray, the user may be unable to carry around necessities throughout the day as walkers generally require the use of both hands of the user. Also, the typical walker tray does not allow the user to properly position themselves inside the walker to walk as the walker is designed. Therefore a suitable solution is desired.

U.S. Pub. No. 2011/0278196 to Molly Hamilton relates to a customizable serving tray. The describe tray includes a customizable serving tray formed from a transparent thermoplastic and having a main portion including an upper side and a lower side, and four raised lateral portions. The main portion of the serving tray is formed from two parallel sheets of thermoplastic and an integral slot on the lower side for receiving a decorative insert, which may include a particular customized graphic thereon. Two of the raised lateral portions, on opposite sides of the main portion, may include apertures forming handles for supporting the serving tray. The remaining two raised lateral portions do not include apertures.

### BRIEF SUMMARY OF THE INVENTION

In view of the foregoing disadvantages inherent in the known walkers and trays art, the present disclosure provides a novel walker tray device. The general purpose of the present disclosure, which will be described subsequently in greater detail, is to provide a clear and see-through tray which is affixable to a walker to improve safety to the user by improving the field of vision and the walker tray device is useful for providing a surface for a user to place articles upon the tray assembly to transport the articles during use.

A walker tray device is disclosed herein, in embodiments. Embodiments of the walker tray device preferably include a tray assembly. The tray assembly includes a front-side, a back-side, a left-side, and a right-side, a top-side, and a bottom-side (as relatively situated during use). The tray assembly is affixable to a walker, with the tray assembly constructed from a transparent material such that surroundings are more viewable to the user through the walker tray device. Such an arrangement improves safety of both the walker and prevents damage to the tray assembly during use.

The tray assembly also includes one or more raised-rings upon the top-side to retain a beverage container during use. Also, the tray assembly includes the front-side, the back-side, the left-side, and the right-side which include raised-portions on the top-side to prevent the articles from sliding from the tray assembly.

Preferably, the walker tray device additionally includes one or more magnets affixed to the tray assembly such that ferrous-metallic (i.e., metallic) articles can be affixed to the walker tray device by the magnets. The magnets are preferably located on both the back-side and the front-side for accessibility. The tray assembly is preferably hingeldy affixed to the walker at the front-side of the tray assembly such that the tray assembly is foldable downward to provide greater access to the walker and also allowing the walker to be folded. Preferably the walker tray device is constructed from an impact-resistant material to provide improved safety, durability, and longevity of use.

According to another embodiment, a method of using a walker tray device is also disclosed herein. The method of using a walker tray device includes a first step; providing a walker tray device; a second step, affixing the walker tray device to a walker; a third step, unfolding the walker tray from a folded position to a ready-for-use position; a fourth step, utilizing the walker to provide stability to a user during use; a fifth step, placing articles upon the walker tray device; a sixth step, affixing articles to the walker tray device via the one or more magnets; a seventh step, removing the articles from the walker tray device; and an eighth step, folding the walker tray assembly into the folded position. Not all steps are required, nor are all steps required to be performed in sequence.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a walker tray device, constructed and operative according to the teachings of the present disclosure.

FIG. 1 is a perspective view of the walker tray device during an ‘in-use’ condition, according to an embodiment of the disclosure.

FIG. 2 is a perspective view of the walker tray device of FIG. 1, according to an embodiment of the present disclosure.

FIG. 3 is a top view of the walker tray device of FIG. 1, according to an embodiment of the present disclosure.

FIG. 4A is a side view of the walker tray device of FIG. 1, according to an embodiment of the present disclosure.

FIG. 4B is a side view of the walker tray device of FIG. 1, according to an embodiment of the present disclosure.

FIG. 4C is a side view of the walker tray device of FIG. 1, according to an embodiment of the present disclosure.

FIG. 5 is a flow diagram illustrating a method of using a walker tray device according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to walkers and trays and more particularly to a walker tray device and method as used to improve the safety, usability and functionality of a walker by providing a tray that is see-though for use with the walker such that the user may more clearly view surroundings during use.

Generally, the walker tray device disclosed herein is a transparent tray for a medical walker which allows the use to see the floor and surroundings while using a walker. The device may include a rectangular tray (or other similar shape) capable of being attached to a walker via hinges or other attachment means. The device may be installed in a standard configuration directly to the walker or attached such that the tray may be moved, rotated, and/or folded as desired.

The tray may be foldable, and may be used when folded or slidable upon a track. The device enables walker users to view the floor, reducing the chance of the user tripping or contacting items over uneven floor surfaces or other obstructions while being able to transport food, drink, and/or other articles. The tray may also feature magnetic portions in order to secure ferrous-metallic articles to the tray in a convenient manner

The walker tray device may be constructed using clear plastic or other suitable materials. The overall tray size may measure approximately 17″ in length and 18.5″ width in preferred embodiments. The trays may be available in various depths in order to accommodate all user needs and preferences.

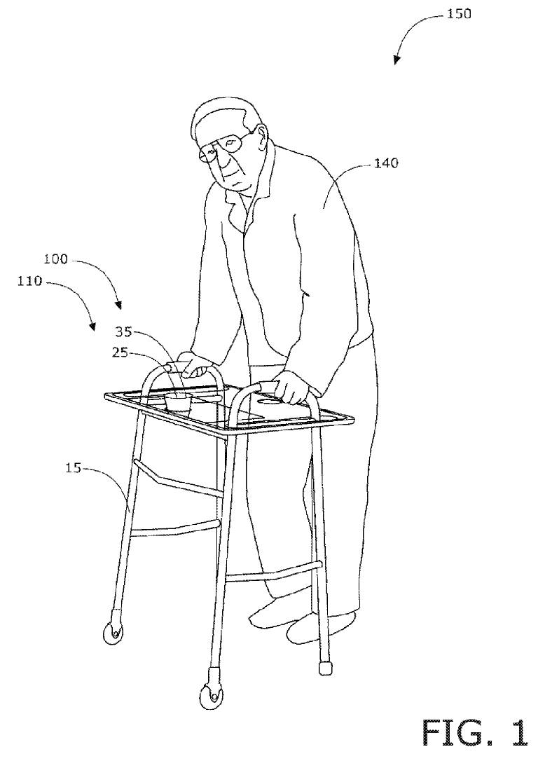

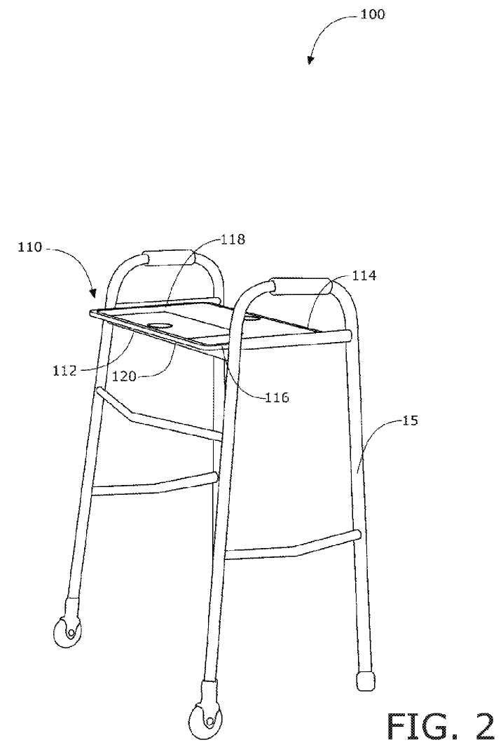

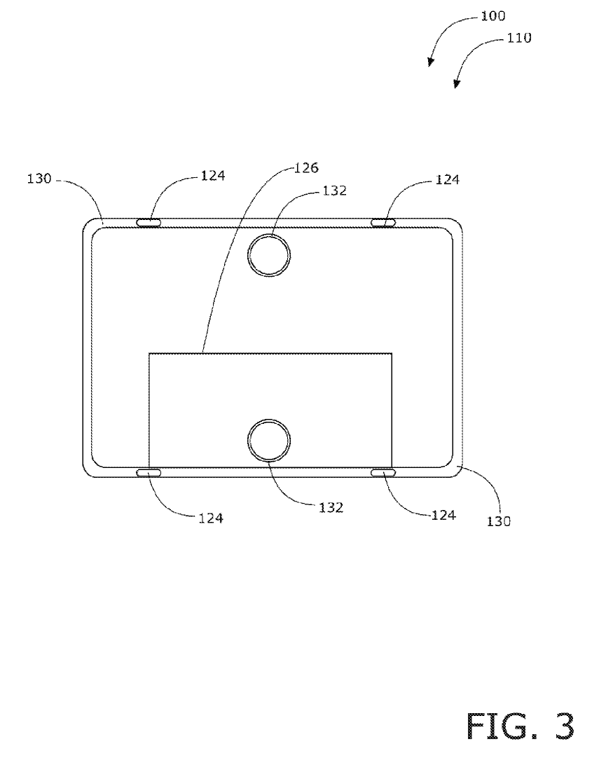

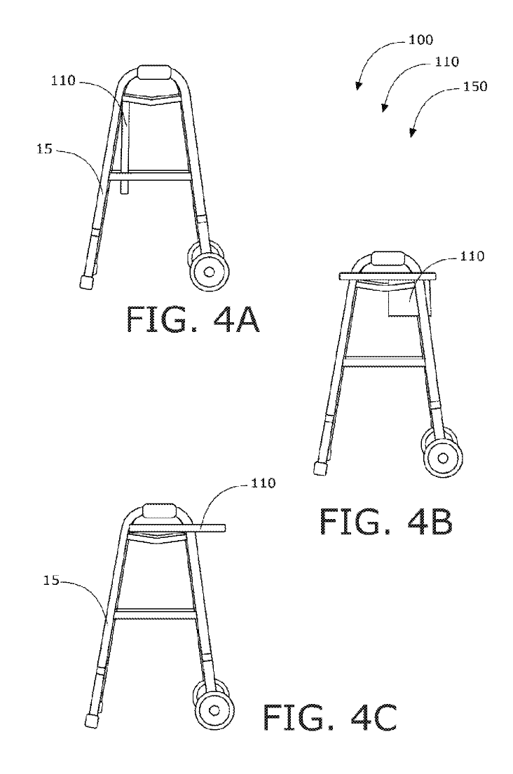

Referring now more specifically to the drawings by numerals of reference, there is shown in FIGS. 1-4C, various views of a walker tray device 100. FIG. 1 shows a walker tray device 100 during an ‘in-use’ condition 150, according to an embodiment of the present disclosure. Here, the walker tray device 100 may be beneficial for use by user 140 to provide a see-through (i.e., transparent, opaque, etc.) tray which may be affixable to walker 15 such that user 140 may see through walker tray device 100 to improve line-of sight and safety. As illustrated, the walker tray device 100 may include tray assembly 110.

As shown in FIGS. 1-4C, tray assembly 110 may include front-side 112, back-side 114, left-side 116, right-side 118, top-side 117, and bottom-side 120, with tray assembly 110 affixable to walker 15. Tray assembly 110 may be constructed from a transparent material such that surroundings are more viewable to user 140 through walker tray device 100 to improve safety during use, and walker tray device 100 may be useful for providing a surface for a user to place articles 25 upon tray assembly 110 to transport articles during use.

According to embodiments, walker tray device 100 may be arranged as a kit 105. In particular, the walker tray device 100 may further include a set of instructions 155. The instructions 155 may detail functional relationships in relation to the structure of walker tray device 100 (such that walker tray device 100 can be used, maintained, or the like, in a preferred manner).

As shown, tray assembly 110 may be defined by front-side 112, back-side 114, left-side 116, and right-side 118 (in any singular side or combination) including raised-portions 130 in a direction of top-side 117 to prevent articles 25 from sliding from tray assembly during use 110. Also, tray assembly 110 may further include one or more raised-rings 132 upon top-side 117 to retain at least one beverage container during use. Further, walker tray device 100 may further include one or more magnets 124 affixed to tray assembly 110 such that ferrous-metallic articles are affixable to walker tray device 100 via magnets 124. Magnets 124 may be located upon back-side 114 in some embodiments. Additional embodiments may also or alternatively include magnets 124 located upon front-side 112 of tray assembly 110.

Tray assembly 110 may also include lockable-hinged-panel 126; lockable-hinged-panel 126 may be rotatable towards bottom-side 120, to provide additional access within walker tray device 100 and walker 15, in some embodiments. Embodiments may also include tray assembly 110 constructed from two-pieces, two-pieces being hingably affixed at right-side 118 and left-side 116 to walker 15 such that tray assembly 110 may be foldable via each of two-pieces into a downward position to provide greater access to walker 15 and the surroundings.

Embodiments of tray assembly 110 may be slideably affixed to walker 15 such that tray assembly 110 may be slidable into one or more extended-positions (e.g., sequentially closed to or farther from user 140) to provide greater access to articles placed upon tray assembly 110. Similarly, one or more extended position may include a first-extended-position and a second-extended position (and/or other extended positions), with each of first-extended-position and second-extended-position (or other extended positions) providing a securably stoppable position for tray assembly 110.

Embodiments may include tray assembly 110 which may be hingeldy affixed to walker 15 at front-side 112 of tray assembly such that tray assembly 110 may be selectably foldable downward (and/or upward) to provide greater access to walker 15, allowing walker 15 to be folded while tray assembly 110 is attached to walker 15. Walker tray device 100 may also include rectangular openings 144 near each of right-side 118 and left side 116 such that tray assembly 110 is removably placeable upon the handles of walker 15 to secure walker tray device 100 upon walker 15.

Walker tray device 100 may be removably secureable to walker 15 in some embodiments. The securing means may include tray assembly 110 removably affixable to walker 15 via a plurality of clamps, walker tray device 100 may be removably affixable to walker 15 via a plurality of straps, and/or walker tray device 100 may be removably affixable to walker 15 via fasteners (e.g., nuts, bolts, washers, screws, nails, etc.). Walker tray device 100 may be constructed from an impact-resistant material to provide improved safety and durability during use.

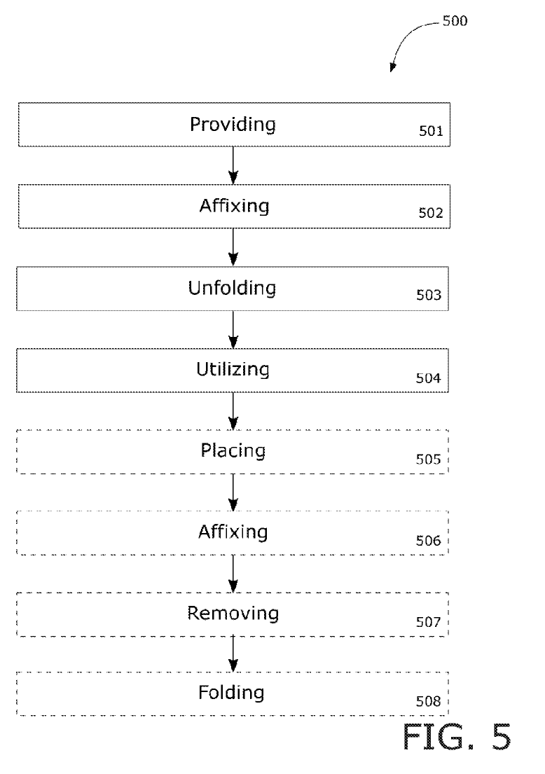

FIG. 5 is a flow diagram illustrating a method of using 500 walker tray device 100, according to an embodiment of the present disclosure. In particular, the method of using 500 a walker tray device 100 may include one or more components or features of the walker tray device 100 as described above. As illustrated, the method of using 500 a walker tray device 100 may include the steps of: step one 501, providing walker tray device 100; step two 502, affixing walker tray device 100 to walker 15; step three 503, unfolding walker tray device 100 from a folded position to a ready-for-use position; step four 504, utilizing walker 15 to provide stability to user 140 during use; step five 505, placing articles 25 upon walker tray device 100; step six 506, affixing articles 25 to walker tray device 100 via one or more magnets 124; step seven 507, removing articles 25 from walker tray device 100; and step eight 508, folding walker tray device 100 into a folded position.

It should be noted that step five 505, step six 506, step seven 507 and step eight 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a walker tray device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A walker tray device, said walker tray device comprising:
a tray assembly, said tray assembly including a front-side, a back-side, a left side, and a right-side, a top-side, and a bottom-side, said tray assembly affixable to a walker; and
wherein said tray assembly is constructed from a transparent material such that surroundings are more viewable to said user through said walker tray device to improve safety during use; and
wherein said walker tray device is useful for providing a surface for a user to place articles upon said tray assembly to transport said articles during use.

2. The walker tray device of claim 1, wherein said tray assembly further includes said front-side, said back-side, said left-side, and said right-side including raised-portions in a direction of said top-side to prevent said articles from sliding from said tray assembly during use.

3. The walker tray device of claim 1, wherein said tray assembly further includes one or more raised- rings upon said top-side to retain at least one beverage container during use.

4. The walker tray device of claim 1, wherein said walker tray device further includes one or more magnets affixed to said tray assembly such that ferrous-metallic articles are affixable to said walker tray device via said magnets.

5. The walker tray device of claim 4, wherein said one or more magnets are located upon said back-side.

6. The walker tray device of claim 4, wherein said one or more magnets are located upon said front-side.

7. The walker tray device of claim 1, wherein said tray assembly includes a lockable-hinged-panel, said lockably-hinged-panel rotatable towards said bottom-side, to provide additional access within said walker tray device.

8. The walker tray device of claim 1, wherein said tray assembly is constructed from two-pieces, said two-pieces being hingably affixed at said right-side and said left-side to said walker such that said tray assembly is foldable via each of said two-pieces into a downward position to provide greater access to said walker.

9. The walker tray device of claim 1, wherein said tray assembly is slideably affixed to said walker such that said tray assembly is slidable into one or more extended-positions to provide greater access to said articles placed upon said tray assembly.

10. The walker tray device of claim 9, wherein said one or more extended position include a first-extended-position and a second-extended position, each of first-extended-position and said second-extended-position providing a securably stoppable position for said tray assembly

11. The walker tray device of claim 1, wherein said tray assembly is hingeldy affixed to said walker at said front-side of said tray assembly such that said tray assembly is foldable downward to provide greater access to said walker and allowing said walker to be folded.

12. The walker tray device of claim 1, wherein said tray assembly is removably affixable to said walker via a plurality of clamps.

13. The walker tray device of claim 1, wherein said walker tray device further includes rectangular openings near each of said right-side and said left side that said tray assembly is removably placeable upon handles of said walker to secure said walker tray device upon said walker.

14. The walker tray device of claim 1, wherein said walker tray device is removably affixable to said walker via a plurality of straps.

15. The walker tray device of claim 1, wherein said walker tray device is removably affixable to said walker via fasteners.

16. The walker tray device of claim 1, wherein said walker tray device is constructed from an impact-resistant material to provide improved safety and durability during use.

17. A walker tray device, said walker tray device comprising:
a tray assembly, said tray assembly including a front-side, a back-side, a left-side, and a right-side, a top-side, and a bottom-side, said tray assembly affixable to a walker, said tray assembly constructed from a transparent material such that surroundings are more viewable to said user through said walker tray device to improve safety during use, said tray assembly including one or more raised-rings upon said top-side to retain at least one beverage container during use, and said tray assembly including said front-side, said back-side, said left-side, and said right-side including raised-portions in a direction of said top-side to prevent said articles from sliding from said tray assembly during use;
one or more magnets affixed to said tray assembly such that ferrous-metallic articles are affixable to said walker tray device via said magnets, said one or more magnets located upon said back-side and said front-side;
wherein said walker tray device is useful for providing a surface for a user to place articles upon said tray assembly to transport said articles during use.
wherein said tray assembly is hingeldy affixed to said walker at said front-side of said tray assembly such that said tray assembly is foldable downward to provide greater access to said walker and allowing said walker to be folded; and
wherein said walker tray device is constructed from an impact-resistant material to provide improved safety and durability during use.

18. The walker tray device of claim 17, further comprising set of instructions; and wherein said device is arranged as a kit.

19. A method of using a walker tray device, said method comprising the steps of:
providing a walker tray device;
affixing said walker tray device to a walker;
unfolding said walker tray from a folded position to a ready-for-use position; and
utilizing said walker to provide stability to a user during use.

20. The method of claim 19, further comprising the steps of:
placing articles upon said walker tray device;
affixing additional articles to said walker tray device via said one or more magnets;
removing said articles from said walker tray device; and
folding said walker tray assembly into said folded position.
